(19) United States
(12) Patent Application Publication
(10) Pub. No.: US 2025/0346459 A1
(43) Pub. Date: Nov. 13, 2025

(54) SPREADER BAR WITH BRACE SUSPENSION SYSTEM

(71) Applicant: Innovatech Systems, LLC, Kanarraville, UT (US)

(72) Inventors: James Barlow, Colorado City, AZ (US); James Harker, Colorado City, AZ (US)

(73) Assignee: Innovatech Systems, LLC, Kanarraville, UT (US)

(21) Appl. No.: 19/195,894

(22) Filed: May 1, 2025

Related U.S. Application Data
(60) Provisional application No. 63/646,203, filed on May 13, 2024.
(60) Provisional application No. 63/676,694, filed on Jul. 29, 2024.

(51) Int. Cl. B66C 1/66; B66C 13/22

(52) U.S. Cl. CPC B66C 1/66; B66C 13/22

(57) ABSTRACT

A panel is coupled to a main spreader bar via one or more lifting cables, and a plurality of temporary braces are coupled via their first end to the panel, wherein each temporary brace is coupled to a respective winch cable at a second end, each winch cable coupled to a spindle on a suspension axle. As the wall is lifted to a vertical position, a user may actuate one or more motors, thereby winding the winch cables on the spindles, which causes the temporary braces to pivot outwardly (the first end being pivotally secured to the panel). Once the desired position of the temporary wall braces is achieved, each temporary wall brace may then be secured to the ground, bracing the panel for the wall in the vertical position during construction.

### CROSS-REFERENCE TO RELATED APPLICATIONS

This application claims the benefit of U.S. Provisional App. Ser. No. 63/646,203, filed May 13, 2024, and further claims the benefit of U.S. Provisional App. Ser. No. 63/676,694, filed Jul. 29, 2024, both of which are incorporated herein by reference.

### TECHNICAL FIELD

The present disclosure relates to raising walls with spreader bars. More particularly, the present disclosure relates to a spreader bar having a brace suspension system.

### BACKGROUND

Wall panels, such as those made of concrete or metal, are often utilized during the construction of large buildings because they are incredibly strong and can withstand extreme weather conditions, heavy loads, and are fire-resistant. Since many wall panels are prefabricated off-site, they can be installed quickly and efficiently during construction. This reduces the overall construction time and labor costs. Further, wall panels can be customized in various shapes, sizes, and finishes to meet specific architectural requirements. This allows for greater design flexibility and aesthetic appeal. This makes them ideal for both residential and commercial buildings. Given the benefits of these wall panels, it is not surprising that they have increased in prevalence. One of the challenges in installing these wall panels during construction is hoisting them into a vertical position and supporting them once in position.

To facilitate the lifting and positioning of these heavy wall panels, spreader bars have become an essential tool in the construction industry. In its simplest form, a spreader bar is a rigid beam designed to evenly distribute the weight of the wall panel, preventing side-to-side tilting during the lifting process. This ensures that the panel remains stable and balanced as it is hoisted into position. Once the panel is positioned vertically, it is typically supported using a series of temporary braces. These braces extend from the panel to the ground at an angle, providing the necessary support to keep the panel upright. Despite their effectiveness, the positioning and securing of these temporary braces requires significant manpower. For example, at least one worker is needed to maneuver each temporary brace during positioning. In other words, if a wall panel needs six temporary braces to be properly supported, six workers would be needed to manage the position of those wall braces. This process is not only time-consuming and expensive due to labor needs, but also poses safety risks due to the proximity of workers to the suspended panel and the crane or other heavy machinery involved in the lifting operation. Ensuring the safety of workers and the stability of the panel during installation remains a critical concern in the construction industry.

Accordingly, there is a need for a spreader bar assembly that reduces the manpower required and increases the speed of placing temporary braces while reducing the risk associated with brace placement by workers. The present disclosure solves these and other problems.

### SUMMARY OF EXAMPLE EMBODIMENTS

In some embodiments, a spreader bar assembly comprises a main spreader bar, a brace suspension axle coupled to the main spreader bar, a plurality of spindles positioned on the brace suspension axle, one or more motors to drive the plurality of spindles, and one or more cables configured to wind/unwind on each respective spindle.

In some embodiments, the spreader bar assembly further comprises a plurality of intermediate spreader bars couplable between the main spreader bar and a panel to be raised. The spreader bar assembly may comprise one or more pulleys to aid in tilting the panel.

In some embodiments of use, a panel is coupled to the main spreader bar via one or more spreader cables, a plurality of temporary braces are coupled via a first end to the panel, with each temporary brace being coupled to a winch cable at a second end, each winch cable coupled to a spindle on the suspension axle. As the panel is lifted to a vertical position, a user may actuate the one or more motors, thereby winding the winch cables on the spindles, which causes the temporary braces to pivot outwardly (the first end being pivotally secured to the panel). Once the desired position and angle of the temporary braces are achieved, each temporary brace may then be secured to the ground to thereby brace the panel during construction.

### BRIEF DESCRIPTION OF THE DRAWINGS

FIG. 1 illustrates a front, side perspective view of spreader bar assembly coupled to a panel to be raised;

FIG. 2 illustrates a front, side perspective view of spreader bar assembly coupled to a panel that has been raised;

FIG. 3 illustrates a detailed, top, front, side perspective view of a spreader bar assembly;

FIG. 4 illustrates a detailed, top, front, side perspective view of a main spreader bar of a spreader bar assembly;

FIG. 5 illustrates a right, side elevation view of a main spreader bar of a spreader bar assembly; and

FIG. 6 illustrates a top plan view of a main spreader bar of a spreader bar assembly.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a spreader bar assembly that reduces the manpower required to maneuver a panel into place, increases the speed of placing temporary braces to support the panel, and reduces the risk associated with temporary brace placement by workers. The spreader bar assembly disclosed herein solves these problems and others. Generally, the spreader bar assembly disclosed herein is configured to distribute the weight of a panel and stabilize it during hoisting, while also positioning the temporary braces at the ideal angle for placement and securement, without requiring a worker for each temporary brace, thereby overcoming the problems in the prior art.

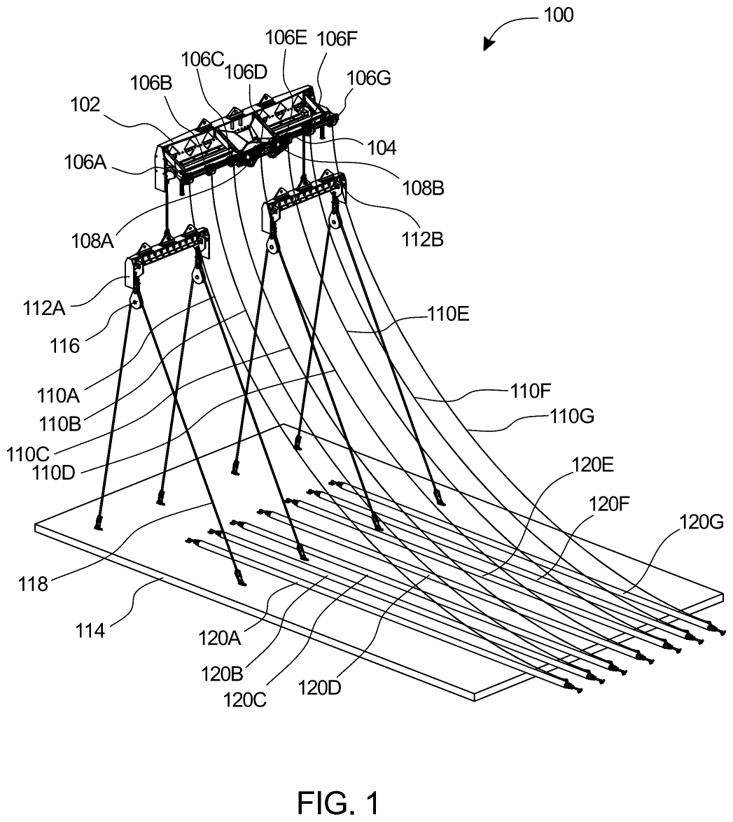

FIGS. 1-4 illustrate, in some embodiments, a spreader bar assembly 100. FIG. 1 illustrates a front, side perspective view of spreader bar assembly 100 coupled to a panel 114 to be raised. In particular, the spreader bar assembly 100 comprises a main spreader bar 102, a brace suspension axle 104 coupled to the main spreader bar 102, a plurality of spindles 106A-G positioned on the brace suspension axle 104, one or more motors 108A-B to drive the plurality of spindles 106A-G, and a respective winch cable 110A-G configured to wind/unwind on each respective spindle 106A-G.

The spreader bar assembly 100 may further comprise a plurality of intermediate spreader bars 112A-B couplable between the main spreader bar 102 and the panel 114 to be raised. The use of intermediate spreader bars 112A-B may provide for additional connection points to the panel 114 (e.g., four connection points instead of two), and may also allow for a wider spread, bringing enhanced stability to the panel 114. The intermediate spreader bars 112A-B may extend beyond the length of the main spreader bar 102. This can be helpful to stabilize panels that are wider than the main spreader bar 102. However, while these intermediate spreader bars 112A-B are shown and described, it will be appreciated that they are not required. In other words, the panel 114 may be coupled directly to the main spreader bar 102 without the need of intermediate spreader bars 112A-B.

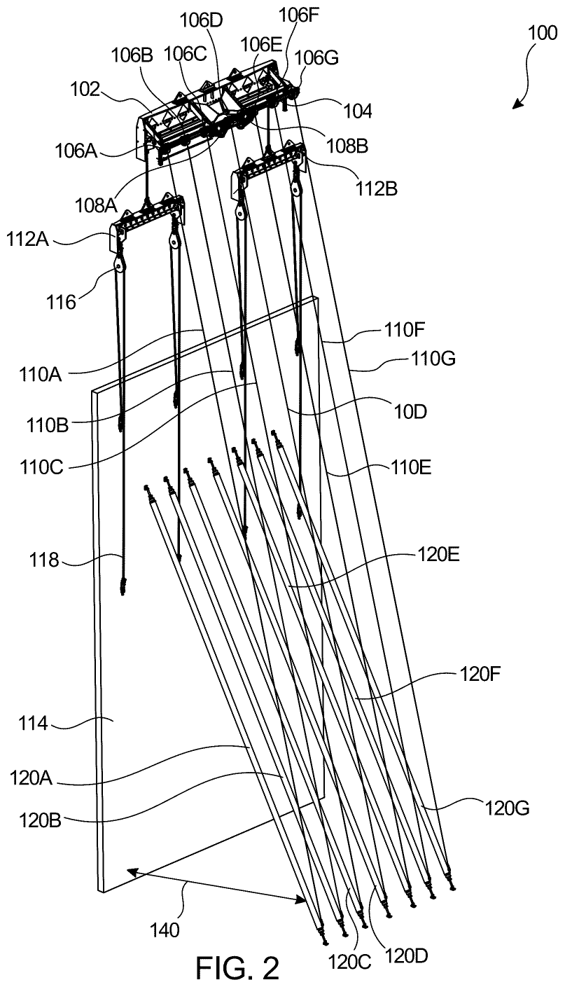

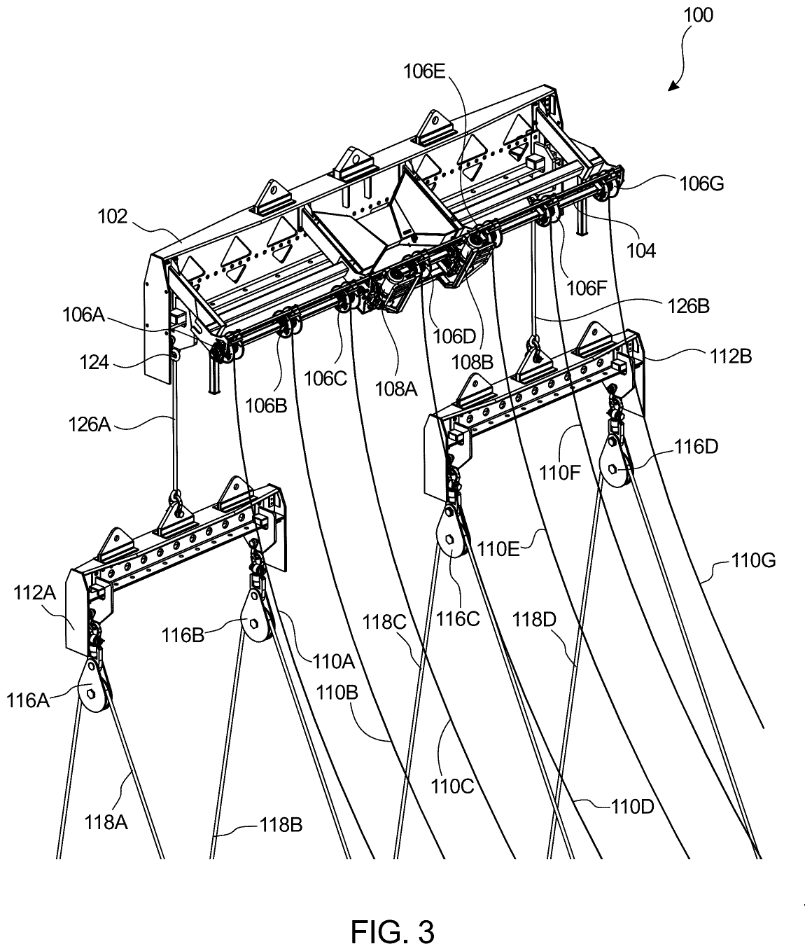

As best seen in FIG. 3, the spreader bar assembly 100 may further comprise one or more pulleys 116A-D to aid in tilting the panel 114 (not visible in FIG. 3), the pulleys 116A-D each comprising a respective lifting cable 118A-D coupled to the panel 114 (best seen in FIGS. 1-2) on a first half of the panel 114 so as to effectively cause the second, lower half of the panel 114 to tilt downwardly as the main spreader bar 102 is raised, as shown in FIG. 2.

In embodiments with intermediate spreader bars 112A-B, the pulleys 116A-D are interposed between the panel 114 and the intermediate spreader bars 112A-B, with the intermediate spreader bars 112A-B coupled to the main spreader bar 102 via extenders 126A-B, respectively. In embodiments without intermediate spreader bars 112A-B, the pulleys 116A-D may be coupled directly to the main spreader bar 102 and interposed between the main spreader bar 102 and the panel 114. For example, one or more pulleys 116A-D may be coupled to a respective frame connector 124 or at a distal end of an extender 126A-B coupled to the frame connector 124.

To maintain the panel 114 supported during construction, a plurality of temporary wall braces 120A-G are pivotably coupled, at a first end, to the panel 114 on the first half of the panel 114, as is currently performed in the art. However, the second end of each temporary wall brace 120A-G is each coupled to a respective winch cable 110A-G. As the panel 114 is lifted and tilts from horizontal (FIG. 1) to vertical (FIG. 2), the motors 108A-B drive the spindles 106A-G, coiling the winch cables 110A-G. As the winch cables 110A-G are coiled, their distal ends, which are coupled to the second end of each respective temporary wall brace 120A-G, begin to lift, which causes each temporary brace 120A-G to pivot outwardly from the panel 114 due to being coupled to the panel 114 at the first end.

Therefore, the spreader bar assembly 100 is capable of simultaneously lifting the panel 114 from horizontal to vertical while also positioning all temporary braces 120A-G at the desired angle via the motors 108A-B. Once the panel 114 is positioned by a crane, one or more workers simply need to secure the second end (ground end) of each temporary brace 120A-G to the ground. This significantly reduces the time required to position and secure the panel 114 and the temporary braces 120A-G associated therewith, reduces the number of workers required, and lessens the risk associated with positioning the panel 114 and the temporary braces 120A-G, overcoming the limitations of the art.

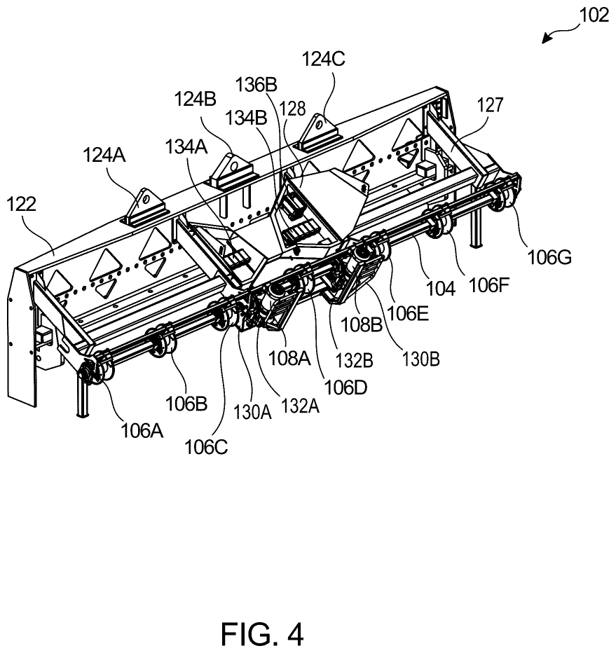

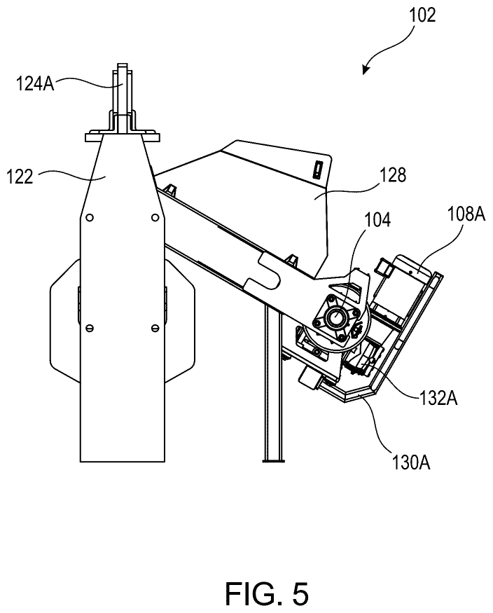

Referring to FIGS. 4-6, the main spreader bar 102 may comprise a frame 122 having one or more hoist brackets 124A-C, a suspension frame 127 coupled to the frame 122, and an electronics housing 128. The suspension frame 127 comprises the brace suspension axle 104, and further comprises motor frames 130A-B for supporting and protecting the motors 108A-B, respectively, as well as gearboxes 132A-B for driving the brace suspension axle 104. The electronics housing 128 comprises one or more batteries 134A-B configured to power the motors 108A-B, and one or more AC drives 136A-B for controlling the voltage and/or frequency of the electrical supply to the one or more motors 108A-B, and to thereby control the speed, torque, and direction of the one or more motors 108A-B. The batteries 134A-B (or battery banks) may each be removable for recharging and replacement. In some embodiments, the batteries 134A-B are coupled to a battery management system (BMS) which is configured to monitor the current state of charge of the one or more batteries 134A-B, and which may charge the batteries 134A-B accordingly. For example, the BMS may be wired to include a charging port at a convenient location on the spreader bar assembly 100. In this manner, when the spreader bar assembly 100 is not in use, a user may couple grid power to the BMS via the port, thereby allowing the BMS to charge the respective batteries 134A-B.

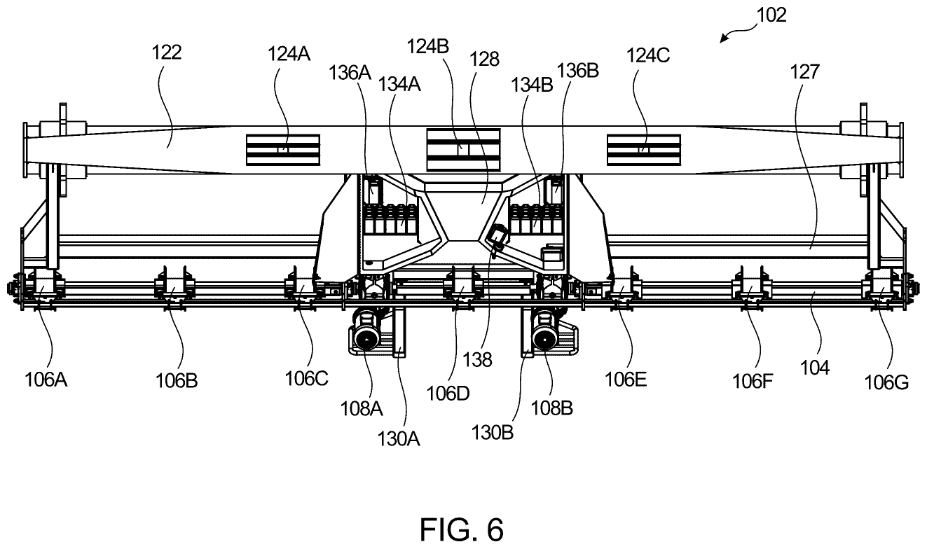

Additionally, each motor 108A-B may be wirelessly controlled using a control module 138 (FIG. 6), the control module 138 comprising a wireless transceiver and configured to control the one or more AC drives 136A-B in response to user input. For example, in some embodiments, a user may use a remote or other handheld device (e.g., smartphone, tablet, etc.) to transmit wireless signals to the control module 138, via the transceiver, to control the motors 108A-B. It will be understood that the control module 138 may comprise components known in the art, such as a microcontroller or other processor. As a result, the control module 138 may send and receive data to and from a user, respectively, via the microcontroller and wireless transceiver.

For example, the control module 138 may be configured to report the status of various components to a user, such as on/off status of the motors 108A-B, RPM of the motors 108A-B, direction of the motors 108A-B, temperature of the motors 108A-B and/or control module 138 and/or batteries 134A-B, the state of charge of the batteries 134A-B, or any other metric or information useful to a user. It will be appreciated that one or more corresponding sensors (e.g., temperature sensor, current sensor, etc.) may be used to gather data from the various components and to report to the control module 138. The control module 138 may then transmit this data to the user. The control module 138 is also configured to receive input from a user from a wireless connected device (e.g., remote, smartphone, tablet, etc.), such as to turn on/off the motors 108A-B, change the direction of rotation of the motors 108A-B, emergency shutdown, or other details.

In some embodiments, the control module 138 may be programmed to activate or deactivate components (e.g., AC drives 136A-B, motors 108A-B, etc.) in response to a triggering event, such as user input (e.g., emergency shutdown) or detecting a sensor reading that meets or exceeds a predetermined threshold or is outside of a predefined acceptable range (e.g., motor 108A-B temperature above a predetermined temperature).

Computing systems have been described herein, such as control module 138. In its most basic configuration, a computing system includes a processor and a computer-readable hardware storage medium that may hold computer-executable instructions for execution by the processor. The processor and the computer-readable medium may be combined, such as by using a microcontroller. A computing system may also include (or are in wired or wireless communication with) a user interface, such as a controller with one or more input triggers (e.g., buttons, touch screen(s), etc.). In some implementations, the computing system(s) is (are) in communication (via a wired or wireless connection) with one or more user interfaces for communicating information to a user and/or receiving user input. The user interface may be a wireless remote (e.g., Bluetooth®, Wi-Fi®, satellite, infrared, etc.) or may be a user's device, such as a smartphone or tablet. When utilizing a user's device, application software may be programmed and deployed to pair and/or interface with the control module 138 or other computing system.

Remote systems/devices may be configured to perform any of the processing described with regard to the control module 138 or other computing system. By way of example, a remote system may include an administrative system that defines operation constraints for the spreader bar assembly 100, receives sensor readings from the sensors (e.g., current sensor, temperature sensor, etc.), and/or issues commands to selectively deactivate the motor/AC drives that are in communication with the computing system.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

In some embodiments, the computing system (e.g., control module 138) includes computer-executable instructions (e.g., stored on storage) that enable the computing system (e.g., by one or more processors executing the computer-executable instructions) to selectively activate or deactivate any portion of the spreader bar assembly 100, such as the AC drives 136A-B, the motors 108A-B, etc. In some instances, the computing system selectively deactivates at least one component of the spreader bar assembly 100 in response to a triggering event. In some instances, the triggering event is detecting that a sensor reading (e.g., current sensor, temperature sensor, etc.) of one or more sensors has met or exceeded a predetermined threshold value or is outside of a predetermined acceptable range.

For example, the computing system may selectively deactivate a component of the spreader bar assembly 100 in response to determining that the motor 108A-B or AC driver 136A-B temperature has exceeded a predefined safe operation temperature. In other instances, the system may selectively deactivate a component of the spreader bar assembly 100 in response to determining that the RPM of the motor 108A-B or gearbox 132A-B is too high, as defined by the user or manufacturer of the component.

Furthermore, the computing system may cause sensor values detected by the various sensors (e.g., current sensor, temperature sensor, etc.) in communication with the computing system to be displayed on a user display or user interface (e.g., an I/O interface and/or a display of a remote system/device, smartphone, tablet, computer, etc.). For example, sensor readings may be displayed on a display of a user/administrator interface associated with the computing system. The computing system may display motor 108A-B status, RPMs, current, SOC of the batteries 134A-B, temperature of the motors 108A-B and inside the electronics housing 128, among others. The input may include various input buttons (i.e., “AUTO”, “ON”, “OFF”) for triggering selective activation/deactivation of the motor 108A-B. The computing system may also include a notifier that indicates when the oil level of the gearbox 132A-B has reached an unacceptably low level, according to the applicable sensor reading. Displaying combinations of sensor readings to a user/administrator may make it easier for a user/administrator to ensure that the spreader bar assembly 100 is operated with due care, so as to avoid damage caused by improper operation thereof.

In some embodiments, the control module 138 may be programmable, such as to allow a user to set the preferred angle of the temporary braces 120A-G by using a set rotation of the spindles 106A-G (or other measurement), to thereby effectuate quick and consistent placement of the temporary braces 120A-G from one panel to the next.

In some embodiments of use, while the panel 114 is laying horizontally, as shown in FIG. 1, one or more workers will couple a first end (i.e., top end) of each temporary brace 120A-G to the panel 114 using methods in the art, such as bolting them to the panel 114. A worker may then couple a second end (i.e., bottom end) of each temporary brace 120A-G to a respective cable 110A-G. The worker may then couple each lifting cable 118 per pulley 116 to the upper half of the panel 114 in preparation for lifting the panel 114. FIG. 3 illustrates an embodiment comprising four pulleys 116A-D each having a respective lifting cable 118A-D.

Referring to FIG. 2, as the panel 114 is lifted to a vertical position, a user may actuate the one or more motors 108A-B, thereby winding the winch cables 110A-G on the spindles 106A-G, which causes the temporary braces 120A-G to pivot outwardly from the bottom of the panel 114 due to being pivotably coupled to the panel 114 at a first, top end. This allows the user to create a distance 140 between the second, bottom end of the temporary braces 120A-G and the panel 114. Once the desired position of the temporary braces 120A-G is achieved (e.g., user selected angle or desired distance 140), each temporary brace 120A-G may then be secured to the ground/surface. Because each temporary brace 120A-G is held at the desired angle and distance via the winch cables 110A-G, a separate worker for each temporary brace 120A-G is not required during installation, which is an important improvement over the prior art. Additionally, workers need not be present to support each temporary brace 120A-G while the panel 114 is being hoisted to position by a crane, since the temporary braces 120A-G are positioned using the winch cables 110A-G, which increases safety over the prior art.

Accordingly, the spreader bar assembly 100 disclosed herein solves the need for a mechanism that increases the speed of placing temporary braces for panels/walls while reducing the risk associated with brace placement by workers.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A spreader bar assembly, comprising:
a main spreader bar comprising a brace suspension axle, at least one spindle positioned on the brace suspension axle, and at least one motor to drive the brace suspension axle; and
at least one winch cable configured to couple to a bottom end of at least one temporary wall brace, the at least one winch cable configured to wind around the at least one spindle.

2. The spreader bar assembly of claim 1, further comprising at least one AC drive configured to control the at least one motor.

3. The spreader bar assembly of claim 2, further comprising a control module configured to control the at least one AC drive.

4. The spreader bar assembly of claim 3, wherein the control module is configured to receive wireless communication and, based on the wireless communication, control the at least one AC drive.

5. The spreader bar assembly of claim 1, further comprising a control module configured to control the at least one motor.

6. The spreader bar assembly of claim 1, further comprising a plurality of intermediate spreader bars coupled to the main spreader bar.

7. The spreader bar assembly of claim 6, wherein each intermediate spreader bar comprises a plurality of pulleys, each pulley having a lifting cable thereon.

8. The spreader bar assembly of claim 1, wherein the main spreader bar further comprises a frame and a suspension frame coupled thereto.

9. The spreader bar assembly of claim 8, wherein the brace suspension axle, the at least one motor, and a gearbox are coupled to the suspension frame.

10. The spreader bar assembly of claim 1, further comprising at least one motor frame to support or protect the at least one motor.

11. A spreader bar assembly, comprising:
a main spreader bar, comprising:
a brace suspension axle,
a plurality of spindles positioned on the brace suspension axle,
at least one motor coupled to a gearbox to drive the brace suspension axle, at least one AC drive configured to control the at least one motor,
a control module configured to control the at least one AC drive, and at least one battery to power the control module, the at least one AC drive, and the at least one motor;
a plurality of temporary wall braces; and
a plurality of winch cables, each winch cable coupled to a bottom end of a respective temporary wall brace of the plurality of temporary wall braces, each winch cable configured to wind around a respective spindle of the plurality of spindles.

12. The spreader bar assembly of claim 11, further comprising a plurality of intermediate spreader bars coupled to the main spreader bar.

13. The spreader bar assembly of claim 12, wherein each intermediate spreader bar comprises a plurality of pulleys, each pulley having a lifting cable thereon.

14. The spreader bar assembly of claim 11, wherein the main spreader bar further comprises a frame and a suspension frame coupled thereto.

15. The spreader bar assembly of claim 14, wherein the brace suspension axle, the at least one motor, and the gearbox are coupled to the suspension frame.

16. The spreader bar assembly of claim 11, further comprising at least one motor frame to support or protect the at least one motor.

17. The spreader bar assembly of claim 11, wherein the control module is configured to receive wireless communication and, based on the wireless communication, control the at least one AC drive.

18. A method of using a spreader bar assembly, comprising:
coupling a top end of a plurality of temporary wall braces to a panel to be hoisted;
coupling a plurality of lifting cables to a top half of the panel, each lifting cable passing over a respective pulley of the spreader bar assembly;
coupling a respective winch cable to a bottom end of each temporary wall brace of the plurality of temporary wall braces, each winch cable configured to wind around a respective spindle, each spindle coupled to a brace suspension axle; and
as the panel is hoisted to a vertical position, actuating a motor to drive the brace suspension axle, thereby winding the winch cables around the respective spindles, wherein the bottom end of each temporary wall brace is pivoted outwardly from the panel.

19. The method of claim 18, further comprising the step of interposing a plurality of intermediate spreader bars between the panel and a main spreader bar, wherein each pulley and respective lifting cable is coupled to a respective intermediate spreader bar.

20. The method of claim 18, further comprising actuating the motor using a wireless device.
